(19) United States
(12) Patent Application Publication
(10) Pub. No.: US 2023/0165340 A1
(43) Pub. Date: Jun. 1, 2023

(54) METHOD AND DEVICE FOR EXTRACTING JOINT LINE OF SHOE

(71) Applicant: METAL INDUSTRIES RESEARCH & DEVELOPMENT CENTRE, Kaohsiung City (TW)

(72) Inventors: Cheng-Chang Chiu, Pingtung County (TW); Chun-Ming Yang, Kaohsiung City (TW); Chia-Pin Lin, Changhua County (TW); Ping-Tzan Huang, Kaohsiung City (TW); Hong-Ren Zhang, Kaohsiung City (TW); Yan-Jun Chen, Kaohsiung City (TW); Wan-Shan Yin, Kaohsiung City (TW)

(21) Appl. No.: 17/535,775

(22) Filed: Nov. 26, 2021

(51) Int. Cl. A43D 27/00

(52) U.S. Cl. CPC A43D 27/00

(57) ABSTRACT

In a method and device for extracting joint line of shoe, a contact end of a contouring tool is provided to contact a joint contour of a shoe sample, an encoder is provided to generate a plurality of first trajectory coordinate signals of the contact end while the contact end is moved along the joint contour, and a signal processor is provided to receive the first trajectory coordinate signals to create a digital joint line.

### FIELD OF THE INVENTION

This invention relates to a method and device for extracting joint line of shoe, which are provided to extract a joint contour of a shoe sample to create a digital joint line.

### BACKGROUND OF THE INVENTION

Attaching a shoe upper to a sole is an important process during shoe production. Conventionally, the shoe upper and the sole are joined to each other by gluing, but glue may be applied over to a shoe vamp during manual gluing to contaminate the shoe vamp. As a result, additional glue removal may be required after gluing.

Taiwan patent 1624230 (application No. 105114358), entitled SYSTEM FOR CREATING VIRTUAL BITE LINES FOR FOOTWEAR AND METHOD FOR PROCESSING SHOE UPPER, discloses that a visible marking agent is provided to mark a bite line 210 on a shoe upper 110 for gluing process. The visible marking agent 210 may be fluorescent material and only detectable by a camera when illuminated by a UV source or IR light source. Image capture of the bite line 210 may be influenced by illumination and shooting angle of the camera, so it is not suitable for automatic gluing of batch production.

### SUMMARY

One object of the present invention is to provide method and device for extracting joint line of shoe. The method and device are used to extract a joint contour of a shoe sample to create a digital joint line such that manipulator and its trajectory can be positioned according to the digital joint line for automatic roughing or gluing during batch production.

A method for extracting joint line of shoe of the present invention includes the steps as follows. A contouring tool including a contact end and at least one first encoder is provided, the contact end is used to contact a joint contour of a shoe sample, and the first encoder is used to generate a coordinate signal of the contact end. The shoe sample is placed on a holder, and the contact end is allowed to contact a starting point of the joint contour to copy the joint contour, and at the same time, the first encoder generates a first initial coordinate signal of the contact end. Next, the contact end is moved along the joint contour until back to the starting point, the first encoder generates a plurality of first trajectory coordinate signals of the contact end during the movement of the contact end along the joint contour. And a signal processor receives the first initial coordinate signal and the first trajectory coordinate signals to create a digital joint line.

A device for extracting joint line of shoe includes a contouring tool, a holder and a signal processor. The contouring tool includes a contact end and at least one first encoder, the contact end is provided to contact a joint contour of a shoe sample, and the first encoder is provided to generate a coordinate signal of the contact end. The first encoder is provided to generate a first initial coordinate signal of the contact end as the contact end contacts a starting point of the joint contour and generate a plurality of first trajectory coordinate signals while the contact end is moved along the joint contour until back to the starting point. The shoe sample is fixed on the holder to allow the contact end to be moved along the joint contour. The signal processor is provided to receive the first initial coordinate signal and the first trajectory coordinate signals to create a digital joint line.

In the present invention, the contact end of the contouring tool contacts the joint contour of the shoe sample and is moved along the joint contour, the first encoder generates the coordinate signals of the contact end, including the first initial coordinate signal and the first trajectory coordinate signals, the signal processor constructs the digital joint line according to the coordinate signals of the contact end. The digital joint line can be used as reference for automatic gluing during batch production to solve problems caused by manual gluing and marking agent in the prior art.

### DESCRIPTION OF THE DRAWINGS

FIG. 1 is a perspective assembly diagram illustrating a device for extracting joint line of shoe in accordance with one embodiment of the present invention.

FIG. 2 is a perspective assembly diagram illustrating the device for extracting joint line of shoe in accordance with one embodiment of the present invention.

FIG. 3 is a perspective diagram illustrating how a contact end contacts a joint contour of a shoe in accordance with one embodiment of the present invention.

### DETAILED DESCRIPTION OF THE INVENTION

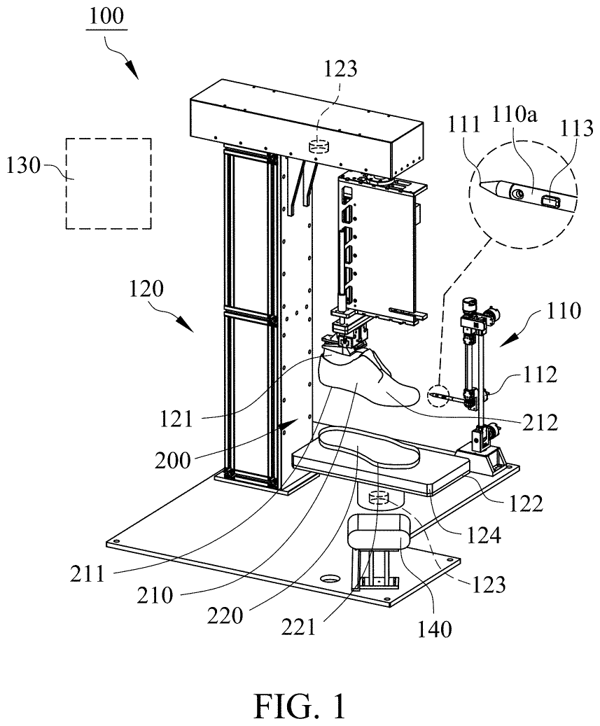

With reference to FIGS. 1 to 3, in a method for extracting joint line of shoe of the present invention, a device 100 is provided to extract a joint contour 230 of a shoe sample 200, which includes a contouring tool 110, a holder 120 and a signal processor 130. The contouring tool 110 may be a bracket with multiple linkage rods or single linkage rod and includes a contact end 111 and at least one first encoder 112. The contact end 111 can contact the joint contour 230, and the first encoder 112 can generate coordinate signal(s) of the contact end 111. The contact end 111 is the terminal of the contouring tool 110 in this embodiment, but the contact end 111 may be not the terminal of the contouring tool 110 in other embodiments.

With reference to FIG. 1, the shoe sample 200 is fixed on the holder 120. In this embodiment, the holder 120 includes a rotation element 121 and a rotation carrier 122, and the shoe sample 120 is clamped between the rotation element 121 and the rotation carrier 122. Preferably, the holder 120 further includes at least one second encoder 123 used to generate coordinate signal(s) of the holder 120.

In accordance with the method for extracting joint line of shoe of the present invention, the shoe sample 200 is placed on the holder 120 as shown in FIG. 1. In this embodiment, a shoe upper 210 of the shoe sample 200 is placed on the rotation element 121 and a shoe sole 220 of the shoe sample 200 is placed on the rotation carrier 122. The rotation element 121 is, but not limited to, a shoe last. Preferably, a flexible sheet 124 is provided on the rotation carrier 122, and the shoe sole 220 is placed on the flexible sheet 124.

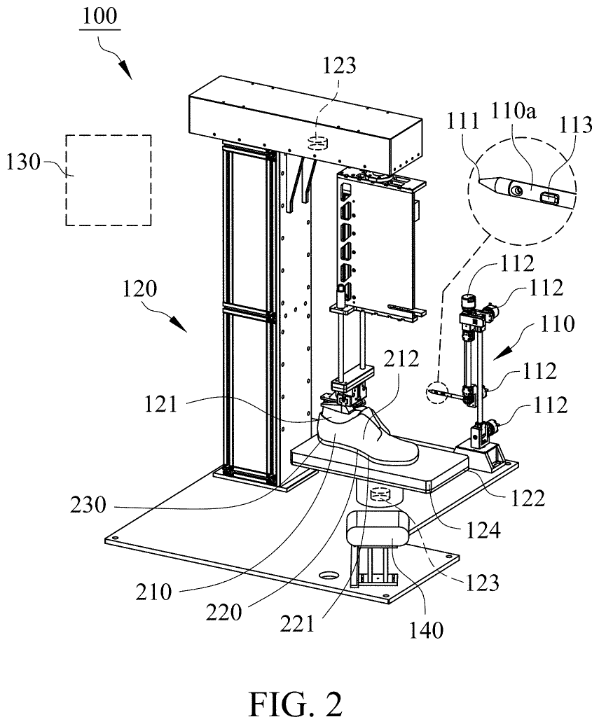

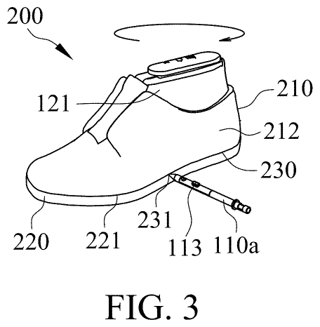

With reference to FIGS. 2 and 3, one or both of the rotation element 121 and the rotation carrier 122 are moved to allow the shoe sole 220 to contact the shoe upper 210 such that the shoe sample 200 is clamped between the flexible sheet 124 and the rotation element 121. As the shoe sole 220 contacts the shoe upper 210, the flexible sheet 124 is contacted and indented by the shoe sole 220 so as to protect the shoe sole 220 from deformation (e.g. warpage). The joint contour 230 may be a contour 221 of the shoe sole 220 or a contour on a surface 212 of the shoe upper 210 defined by the contour 221 of the shole sole 220.

With reference to FIGS. 2 and 3, next, one or both of the holder 120 and the contouring tool 110 are moved to allow the contact end 111 of the contouring tool 110 to contact a starting point 231 on the joint contour 230. The contact end 111 is, but not limited to, an end of a rod 110a of the contouring tool 110. As the contact end 111 contacts the starting point 231 on the joint contour 230, a first initial coordinate signal of the contact end 111 is generated by the first encoder 112, a second initial coordinate signal of the holder 120 is generated by the second encoder 123, and the first and second initial coordinate signals are transmitted to the signal processor 130. In this embodiment, the second initial coordinate signal is a coordinate signal of the rotation element 121.

With reference to FIGS. 2 and 3, after contacting the starting point 231 of the joint contour 230, the contact end 111 is moved along the joint contour 230 and back to the starting point 231. In this embodiment, the shoe sample 200 is rotated by the holder 120, in other words, the shoe sample 200 is rotated by the rotation element 121 and the rotation carrier 122 to allow the contact end 111 to be moved along the joint contour 230. While the contact end 111 is moved back to the starting point 231 along the joint contour 230, a plurality of first trajectory coordinate signals of the contact end 111 are generated by the first encoder 112, a plurality of second trajectory coordinate signals of the holder 120 are generated by the second encoder 123, and the first and second trajectory coordinate signals are sent to the signal processor 130. In this embodiment, the second trajectory coordinate signals are coordinate signals of the rotation element 121.

With reference to FIGS. 1 and 3, the contouring tool 110 of this embodiment further includes a switch 113 which is electrically connected to the signal processor 130. As the contact end 111 contacts the starting point 231 on the joint contour 230, the switch 113 is turned ON to lead the signal processor 130 to receive the first and second initial coordinate signals. And when the contact end 111 is moved along the joint contour 230, the switch 113 is turned ON intermittently to allow the signal processor 130 to receive the first and second trajectory coordinate signals intermittently.

With reference to FIGS. 1 to 3, the signal processor 130 receives the first initial coordinate signal, the second initial coordinate signal, the first trajectory coordinate signals and the second trajectory coordinate signals to create a digital joint line L. And a roughing region or a roughing path of the shoe upper 210 of the shoe sample 200 can be defined by the signal processor 130 according to the digital joint line L.

With reference to FIGS. 1 and 3, preferably, a scanner 140 (such as 3D camera) of the device 100 is provided to scan a bottom 211 of the shoe upper 210 to construct a 3D digital model of the bottom 211 before the shoe sole 220 contacts the shoe upper 210 or after the contact end 111 is moved back to the starting point 231 along the joint contour 230. The signal processor 130 receives the 3D digital model and merge the 3D digital model with the digital joint line L to define a gluing region or a gluing path of the shoe upper 210 of the shoe sample 200.

While the contact end 111 of the contouring tool 110 is contacted and moved along the joint contour 230 of the shoe sample 200, the first encoder 112 generates the coordinate signals of the contact end 111, including the first initial coordinate signal and the first trajectory coordinate signals, the second encoder 123 generates the coordinate signals of the holder 120, including the second initial coordinate signal and the second trajectory coordinate signals, and the signal processor 130 receives the coordinate signals of the contact end 111 and the holder 120 to construct the digital joint line L. Preferably, the digital joint line L and the 3D digital model of the bottom 211 of the shoe upper 210 are merged and used as setting reference of digital information for automatic batch production, such that it is possible to solve problems resulted from manual gluing and marking agent in the prior art.

While this invention has been particularly illustrated and described in detail with respect to the preferred embodiments thereof, it will be clearly understood by those skilled in the art that is not limited to the specific features shown and described and various modified and changed in form and details may be made without departing from the scope of the claims.

What is claimed is:

1. A method for extracting joint line of shoe comprising the steps of:
providing a contouring tool including a contact end and at least one first encoder, the contact end is configured to contact a joint contour of a shoe sample, and the at least one first encoder is configured to generate at least one coordinate signal of the contact end;
placing the shoe sample on a holder;
copying the joint contour, wherein the contact end is configured to contact a starting point on the joint contour to allow the at least one first encoder to generate a first initial coordinate signal of the contact end, then the contact end is configured to be moved along the joint contour and back to the starting point to allow the at least one first encoder to generate a plurality of first trajectory coordinate signals of the contact end; and
receiving the first initial coordinate signal and the plurality of first trajectory coordinate signals to create a digital joint line by a signal processor.

2. The method in accordance with claim 1, wherein the holder is configured to rotate the shoe sample and includes at least one second encoder which is configured to generate at least one coordinate signal of the holder, the at least one second encoder is configured to generate a second initial coordinate signal of the holder as the contact end contacts the starting point on the joint contour and configured to generate a plurality of second trajectory coordinate signals of the holder while the contact end is moved along the joint contour and back to the starting point, the signal processor is configured to receive the second initial coordinate signal and the plurality of second trajectory coordinate signals to create the digital joint line.

3. The method in accordance with claim 1 further comprising a step of scanning a bottom of a shoe upper of the shoe sample by a scanner to construct a 3D digital model of the bottom of the shoe upper, wherein the signal processor is configured to receive and merge the 3D digital model with the digital joint line.

4. The method in accordance with claim 2 further comprising a step of scanning a bottom of a shoe upper of the shoe sample by a scanner to construct a 3D digital model of the bottom of the shoe upper, wherein the signal processor is configured to receive and merge the 3D digital model with the digital joint line.

5. The method in accordance with claim 1, wherein the signal processor is configured to define a roughing region or a roughing path of a shoe upper of the shoe sample according to the digital joint line.

6. The method in accordance with claim 2, wherein the signal processor is configured to define a roughing region or a roughing path of a shoe upper of the shoe sample according to the digital joint line.

7. The method in accordance with claim 2, wherein the holder includes a rotation element and a rotation carrier, a shoe upper of the shoe sample is configured to be placed on the rotation element, a shoe sole of the shoe sample is configured to be placed on the rotation carrier, and the shoe sample is configured to be clamped between the rotation element and the rotation carrier, the second initial coordinate signal and the plurality of second trajectory coordinate signals generated by the at least one second encoder are coordinate signals of the rotation element.

8. The method in accordance with claim 7, wherein the shoe sole is configured to be placed on a flexible sheet of the rotation carrier and the shoe sample is configured to be clamped between the flexible sheet and the rotation element.

9. The method in accordance with claim 1, wherein the contouring tool further includes a switch which is electrically connected to the signal processor, the switch is configured to be turned on intermittently while the contact end is moved along the joint contour and configured to allow the signal processor to receive the plurality of first trajectory coordinate signals intermittently.

10. The method in accordance with claim 9, wherein the signal processor is configured to receive the plurality of second trajectory coordinate signals intermittently while the switch is turned on intermittently.

11. A device for extracting joint line of shoe comprising:
a contouring tool including a contact end and at least one first encoder, the contact end is configured to contact a joint contour of a shoe sample, the at least one first encoder is configured to generate at least one coordinate signal of the contact end, wherein the at least one first encoder is configured to generate a first initial coordinate signal of the contact end as the contact end contacts a starting point on the joint contour and configured to generate a plurality of first trajectory coordinate signals of the contact end while the contact end is moved along the joint contour and back to the starting point;
a holder configured to fix the shoe sample and allow the contact end to be moved along the joint contour; and
a signal processor configured to receive the first initial coordinate signal and the plurality of first trajectory coordinate signals to create a digital joint line.

12. The device in accordance with claim 11, wherein the holder is configured to rotate the shoe sample and includes at least one second encoder which is configured to generate at least one coordinate signal of the holder, the at least one second encoder is configured to generate a second initial coordinate signal of the holder as the contact end contacts the starting point on the joint contour and configured to generate a plurality of second trajectory coordinate signals of the holder while the contact end is moved along the joint contour and back to the starting point, the signal processor is configured to receive the second initial coordinate signal and the plurality of second trajectory coordinate signals to create the digital joint line.

13. The device in accordance with claim 11 further comprising a scanner, wherein the scanner is configured to scan a bottom of a shoe upper of the shoe sample to construct a 3D digital model of the bottom of the shoe upper, the signal processor is configured to receive and merge the 3D digital model with the digital joint line.

14. The device in accordance with claim 12 further comprising a scanner, wherein the scanner is configured to scan a bottom of a shoe upper of the shoe sample to construct a 3D digital model of the bottom of the shoe upper, the signal processor is configured to receive and merge the 3D digital model with the digital joint line.

15. The device in accordance with claim 12, wherein the holder includes a rotation element and a rotation carrier, the rotation element is configured for placement of a shoe upper of the shoe sample, the rotation carrier is configured for placement of a shoe sole of the shoe sample, the shoe sample is configured to be clamped between the rotation element and the rotation carrier, and the second initial coordinate signal and the plurality of second trajectory coordinate signals generated by the at least one second encoder are coordinate signals of the rotation element.

16. The device in accordance with claim 15, wherein a flexible sheet on the rotation carrier is configured for placement of the shoe sole of the shoe sample, and the shoe sample is configured to be clamped between the flexible sheet and the rotation element.

17. The device in accordance with claim 11, wherein the contouring tool further includes a switch which is electrically connected to the signal processor, the switch is configured to allow the signal processor to receive the plurality of first trajectory coordinate signals intermittently while the contact end is moved along the joint contour.

18. The device in accordance with claim 17, wherein the switch is configured to allow the signal processor to receive the plurality of second trajectory coordinate signals intermittently.
